(19) United States
(12) Patent Application Publication
(10) Pub. No.: US 2007/0104482 A1
(43) Pub. Date: May 10, 2007

(54) Recording medium drying apparatus

(75) Inventor: Shigeru Ando, Kanagawa (JP)

Correspondence Address: TAIYO CORPORATION, 401 HOLLAND LANE, #407, ALEXANDRIA, VA, 22314, US

(73) Assignee: FUJIFILM CORPORATION

(21) Appl. No.: 11/585,945

(22) Filed: Oct. 25, 2006

(30) Foreign Application Priority Data
Nov. 7, 2005 (JP) 2005-322551
Dec. 1, 2005 (JP) 2005-348141

(51) Int. Cl. G03D 13/00

(52) U.S. Cl. 396/564

(57) ABSTRACT

Disclosed is a recording medium drying apparatus for removing liquid droplets on a recording medium surface by air blown from a blowing unit provided upstream in a conveying direction of a mesh belt for holding and conveying the recording medium. The recording medium drying apparatus may comprise a conveying belt whose outer periphery faces the reverse side of [ ] the photosensitive material, for conveying the photosensitive material vertically upward, and a drying mechanism for drying the photosensitive material by blowing drying air, from a blowing slit formed at a position opposite to the outer periphery at the conveying portion of the conveying belt, toward the conveying belt.

### CROSS-REFERENCE TO RELATED APPLICATIONS

This application claims priority under 35 USC 119 from Japanese Patent Applications Nos. 2005-322551 and 2005-348141, the disclosures of which are incorporated by reference herein.

### BACKGROUND OF THE INVENTION

1. Technical Field

The present invention relates to a recording medium drying apparatus, and more particularly to a recording medium drying apparatus having an air squeezing device for removing liquid droplets from surfaces of a photosensitive material which has been subjected to a developing process with a treating solution. The invention further relates to a photosensitive material drying apparatus structured so as to give a reduced footprint.

2. Related Art

Hitherto, a so-called mini laboratory system has been used as a processing apparatus capable of developing photographs in a limited space of a general office rather than that of a large scale processing laboratory.

In an input machine of a mini laboratory system digital image data from negative film, positive film, magnetic recording medium, or optical recording medium is read out. The digital image data read out from the input machine is exposure-processed onto photosensitive material in an exposure unit of the mini laboratory output machine, and by developing the prints are finished

In the mini laboratory system, a color print or a photosensitive material, which has been exposure-processed based on the digital image data sent from the input machine, is conveyed, for example, into an automatic developing device, and is immersed in a developing solution to be developed, immersed in a fixing solution to be fixed, immersed in rinsing water to be rinsed, and conveyed to a drying section to be dried. In this manner, a completed product of developed color prints is obtained.

At this time, the photosensitive material, which has been subjected to the wet developing process in the automatic developing device, has a portion of the water removed in a squeezing section, is then dried in the drying section, and then discharged as a print. For water removal in the squeezing section, the photosensitive material is generally passed between a plurality of roller pairs, and thus moisture on the photosensitive material surface is squeezed out so that water droplets are squashed out to be flat with a wide surface area, thereby facilitating the subsequent drying process.

However, in a case where the photosensitive material is sheet-like, there is a tendency that water droplets are still left over at the trailing edge of the photosensitive material even after the photosensitive material has been passed through the squeezing section, and hence if the photosensitive material is dried quickly, blemishes due to water droplets on the trailing edge are caused to occur in the prints. Hence, a drying process has been proposed in which heated compressed air is sprayed out of nozzles and blown onto the surfaces of the photosensitive material (for example, refer to Japanese Patent Laid-Open Publication (JP-A) No. 06-027629).

To prevent the occurrence of blemishes due to water droplets on the trailing edge, it is required to remove water droplets on the trailing edge of the sheet-like photosensitive material in a very short time period between the end of the squeezing process till the start of the drying process. Thus, if compressed air is blown uniformly from multiple nozzles, as in JP-A No. 06-027629, wind pressure from each nozzle may be lowered, and water droplets on the trailing edge may not be removed completely.

In the photosensitive material drying apparatus, which serves as recording medium drying apparatus, in order to make the footprint smaller, the conveying belt is disposed obliquely, and the photosensitive material is conveyed obliquely upward (for example, refer to JP-A No. 2000-3019). In such apparatus, the conveying belt is provided with anti-slipping means in order to prevent conveyance trouble.

However, with such conventional photosensitive material drying apparatus, when the inclination angle of the conveying belt is increased, conveyance trouble or a state in which the photosensitive surface is rubbed tends occur so that the photosensitive material may not be conveyed vertically upward in a satisfactory manner.

The present invention has been made in order to solve the above-mentioned problems.

### SUMMARY

In view of the above-described circumstances, the present invention provides a recording medium drying apparatus which is designed so as to eliminate the influence of water droplets on the trailing edge on the print quality. Further, the present invention also provides a photosensitive material drying apparatus serving as a recording medium drying apparatus, which is structured such that the footprint can be reduced.

A first aspect of the invention provides a recording medium drying apparatus wherein a recording medium, which has been subjected to a liquid impregnation process, is pressed against a circulating mesh belt by blowing air from an image recording surface side to the recording medium, and dried while being held on the circulating mesh belt and conveyed, the apparatus comprising: a blowing unit provided upstream in the conveying direction of the mesh belt and structured such that liquid droplets on the surface of the recording medium are removed with air blown from the blowing unit.

A second aspect of the invention provides A photosensitive material drying apparatus comprising: an endless conveying belt, whose outer periphery faces the reverse face of the photosensitive material, for conveying the photosensitive material vertically upward by circulating motion; and a drying mechanism, for drying the photosensitive material by blowing drying air from the blowing slit toward the conveying belt, having a blowing slit formed at a position opposite to, and at a distance L (mm) that is 6 mm≦L≦10 mm from, the outer periphery at the conveying portion of the conveying belt, wherein the velocity V (m/s) of the drying air is V≧6 m/s, and the relationship between the velocity V (m/s) of the drying air and a coefficient of static friction μ of the conveying belt is μ≧20.0082 V²−0.1968 V+1.3 (when 6≦V≦12), or μ>20.10 (when V>12).

Other aspects, features, and advantages of the invention will be further clarified from the following description given in conjunction with the accompanying drawings.

### BRIEF DESCRIPTION OF THE DRAWING

FIG. 1 is a diagrammatic view illustrating a printer processor (image forming apparatus) to which a first embodiment of the invention can be applied;

FIGS. 2A to 2C are views showing a drying section according to the first embodiment of the invention;

FIGS. 3A and 3B are views showing details of the drying section according to the first embodiment of the invention;

FIG. 4 is a view showing further details of the drying section according to the first embodiment of the invention;

FIG. 5 is a perspective view of a structure of the drying section according to the first embodiment of the invention;

FIG. 6 is a table showing the residual water droplets prevention effect by the structure of the first embodiment of the invention;

FIG. 7 is a graph showing the residual water droplets prevention effect by the structure of the first embodiment of the invention;

FIG. 8 is a diagrammatic view illustrating the overall structure of a printer processor to which a drying apparatus according to a second embodiment of the invention is applied;

FIG. 9 is a schematic sectional view showing the drying apparatus according to the second embodiment of the invention;

FIG. 10 is a partially cut-away perspective view of the drying apparatus according to the second embodiment of the invention;

FIG. 11 is a graph showing test results of test examples 1 and 2 in the second embodiment of the invention;

FIG. 12 is a schematic diagram showing important elements of test example 3 in the second embodiment of the invention; and

FIG. 13 is a graph showing test results of test examples 3 to 5 in the second embodiment of the invention.

### DETAILED DESCRIPTION

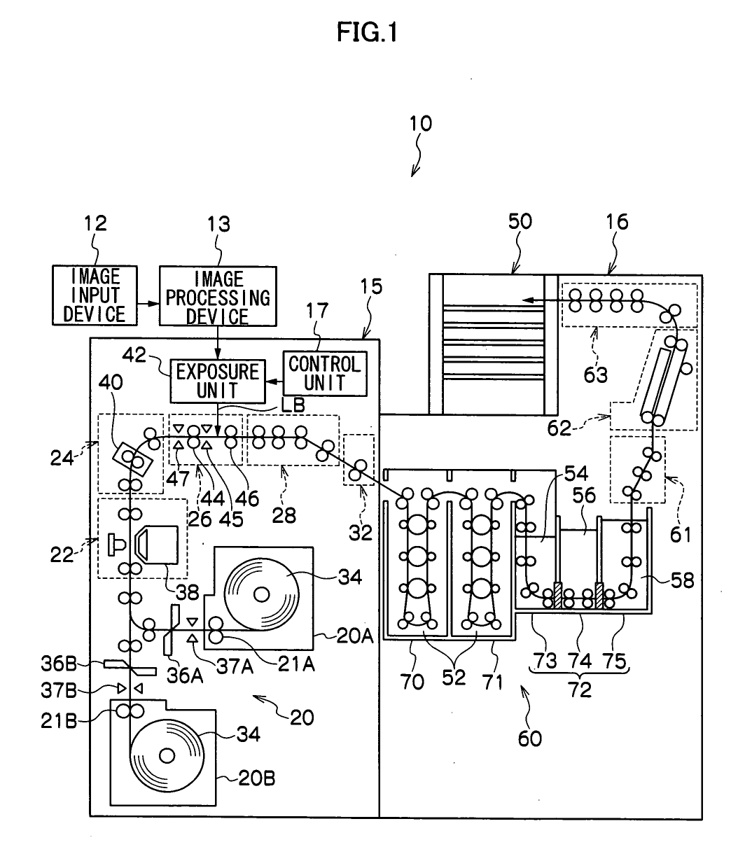

A first embodiment of the invention will be described below with reference to FIG. 1 to FIG. 7.

As shown in FIG. 1, a printer processor 10 of the invention includes an image input device 12, an image processing device 13, a printer 15, a processor 16, and a sorter 50. Components of the printer processor 10 are connected to a control unit 17 through wiring (not shown), and the entire operation of the printer processor 10 is controlled by the control unit 17.

The image input device 12 generates image data by photo-electrically reading projected light of an image recorded on photographic film using an image pickup device such as CCD image sensor, and acquires image data by reading out the image data recorded in a recording medium such as memory card. The image data is sent to the image processing device 13, and subjected to image processing such as color balance correction or contrast correction. The image data that has been subjected to image processing is sent to the printer 15 to be used for image recording operation as described hereinafter.

The printer 15 conveys the recording paper 1 cut to a specified length, and records the image by the recording light modulated in intensity on the basis of the image data. The printer 15 includes, sequentially from the upstream side of conveying direction, a supply unit 20, a back printing unit 22, a registration unit 24, an image recording unit 26, a sub-scanning receiving unit 28, and a delivery unit 32,. At each location, plural conveying roller pairs each composed of a drive roller and a nip roller are provided along the conveying path of the cut recording paper 1.

The supply unit 20 accommodates magazines 20A, 20B for storing rolls of elongate photosensitive recording paper 34. The magazines 20A, 20B are provided with draw-out roller pairs 21A, 21B for drawing out the photosensitive recording paper 34, and conveying it toward the back printing unit 22. In this embodiment, the two magazines 20A, 20B are provided, but one or three or more such magazines may be used.

At the exits of magazines 20A, 20B, cutters 36A, 36B are installed for cutting off the photosensitive paper 34. The cutters 36A, 36B are driven by a control signal received from the control unit 17, and cut the photosensitive paper 34 sent out at a specified length according to print size, corresponding to cut recording paper 1. The print sizes include L (89×127), panorama (89×254), 2L (127×178), octo (165×216), sexto (203×254), and quarto (254×305), and in the embodiment, for example, the width direction orthogonal to conveying direction corresponding to the cut recording paper 1 is 89, 95, 102, 117, 120, 127, 130, 152, 165, 178, 203, 210, 216, 254, and 305. All units are mm.

In the present embodiment, guillotine type cutters are used, but any known cutters such as rotary cutters using rotary blades may be used.

The back printing unit 22 has a back printing head 38 for printing the print information such as date of photographing, print date, frame number, and various ID data, on the non-recording side (opposite side to exposure side) of cut recording paper 1. The back printing head 38 is not specific, as long as it is capable of withstanding the wet developing process, and may be a dot impact head, ink jet head, thermal transfer print head, and any known print head.

The registration unit 24 is composed of a registration roller pair 40 for adjusting the inclination of cut recording paper 1 and position in the width direction for prevention of misalignment of exposure position and angle in the image recording unit 26, and a plurality of conveying roller pairs disposed before and after the registration roller pair 40. Method of adjusting the inclination and position in width direction by registration roller pair 40 includes tilt registration, top registration, side registration, and other known methods.

The image recording unit 26 is composed of an exposure unit 42, sub-scanning roller pairs 44, 46, and recording paper sensors 45, 47 for detecting passing of cut recording paper 1, and the operation is controlled by the control unit 17. The exposure unit 42 is connected to the image processing device 13, and when passing of the leading edge of cut recording paper 1 is detected by the recording paper sensor 45, light beams LB of red, green and blue, which are modulated in intensity on the basis of the image data, are emitted in the main scanning direction (direction orthogonal to conveying direction), and the image is recorded on the cut recording paper 1. The sub-scanning roller pairs 44, 46 are disposed at the upstream side and downstream side of the conveying direction respectively so as to be either side of the position of exposure by light beams LB, and convey the cut recording paper 1 at a specified speed in sub-scanning direction (direction parallel to conveying direction). Nip rollers of the sub-scanning roller pairs 44, 46 are designed to be changed over between the position for holding the cut recording paper 1 and the position where they are spaced apart from the cut recording paper 1, and the change-over is effected when the leading edge or trailing edge of cut recording paper 1 is detected by the recording paper sensor 47. As a result, it is possible to prevent excessive impact from being applied to the cut recording paper 1 due to collision of leading edge of cut recording paper 1 against the sub-scanning roller pair 46 at the downstream side, or slipping of the trailing edge through the sub-scanning roller pair 44 at the upstream side.

The sub-scanning receiving unit 28 includes a plurality of roller pairs for holding the leading edge of the cut recording paper 1 sent out from the image recording unit 26 during the image recording process, and sends out the cut recording paper 1 to the downstream side at same speed as the conveying speed by the image recording unit 26. Each recording pair of sub-scanning receiving unit 28 is composed of a drive roller and a nip roller that is capable of canceling the nip, and holds the cut recording paper 1 after the leading edge of the cut recording paper 1 passes during image recording process. As a result, it is effective in preventing fluctuations of conveying speed due to collision of leading edge of cut recording paper 1.

The delivery unit 32 conveys the cut recording paper 1 fed from the sub-scanning receiving unit 28 at a speed corresponding to the processing speed of the processor 16, and sends to the processor 16.

The processor 16 is composed of a developing section 60, a squeezing unit 61, a drying section 62, and a delivery unit 63. The developing section 60 includes a color developing tank 70, a bleaching fixing tank 71, and a stabilizing tank 72 composed of first stabilizing tank 73, second stabilizing tank 74, and third stabilizing tank 75, disposed sequentially from the upstream side of conveying direction. The color developing tank 70 stores a color developing solution, the bleaching fixing tank 71 stores a bleaching fixing solution, and the first stabilizing tank 73 to third stabilizing tank 75 store stabilizing solutions, each by a specified amount, and the cut recording paper 1 is conveyed in the treating tanks 70 to 72 by driving force from conveying racks 52, 54, 56, 58 provided respectively in the color developing tank 70, bleaching fixing tank 71, and first stabilizing tank 73 to third stabilizing tank 75, and is colored and developed, bleached and fixed, and stabilized.

The squeezing unit 61 is disposed above the third stabilizing tank 75, and is composed of blade, blasting duct, and conveying roll. The blade contacts with both sides of the cut recording paper 1 conveyed by the conveying roll, and scrapes off the treating solution from the cut recording paper 1, and the blasting duct blows air toward the cut recording paper 1 conveyed by the conveying roll, and blows out the treating solution from the cut recording paper 1.

The drying section 62 is disposed above the squeezing unit 61, and is composed of conveying belt and blasting duct. The blasting duct blows a drying air heated by a heater toward the conveying belt 6, and presses the cut recording paper 1 to the conveying belt 6 side. In this state, it is passed before the blasting duct, and the treating solution sticking to the cut recording paper 1 is completely removed. The cut recording paper 1 passes the drying section 62 and is discharged into the sorter 50 by delivery unit 63.

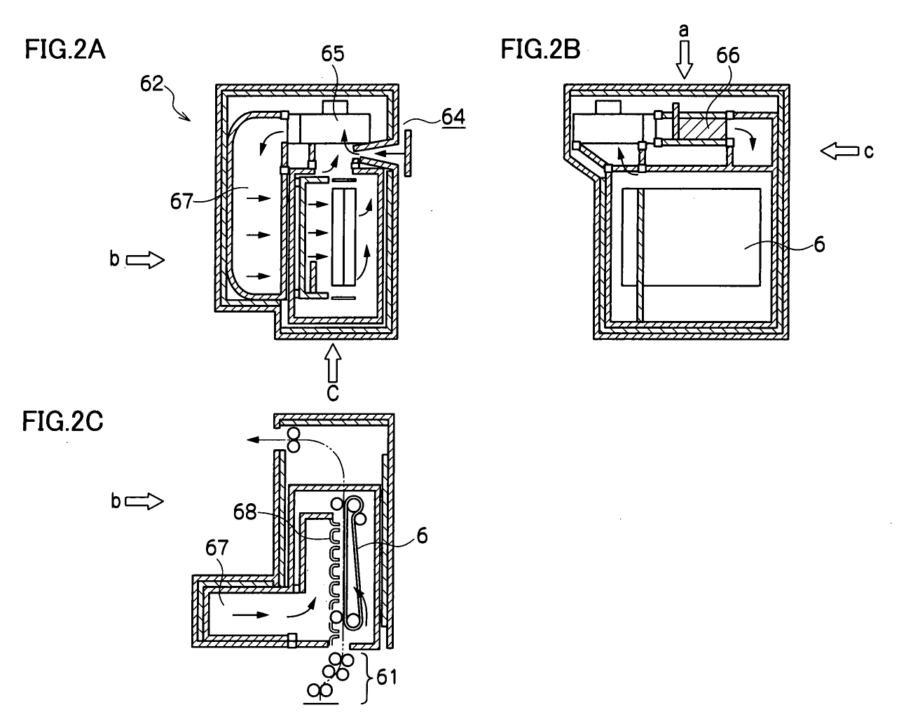

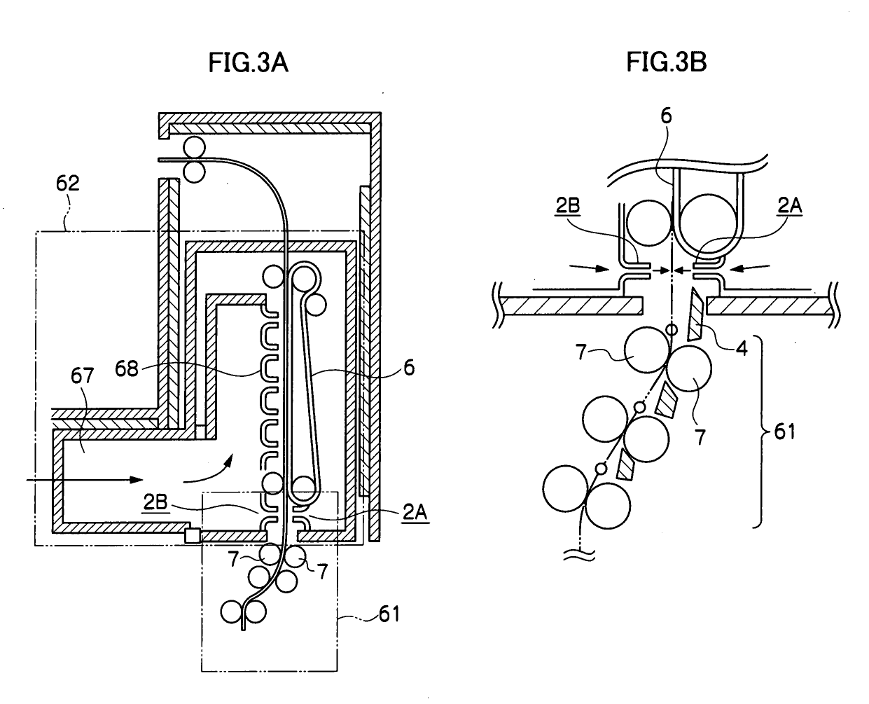

FIGS. 2 and 3 show the drying section of the image recording device according to the first embodiment of the invention.

As shown in FIG. 2A (plan view), FIG. 2B (back view), and FIG. 2C (side view), in the drying section 62, fresh air sucked in from an intake port 64 is pressurized by a drying fan 65, and heated by a heater 66, and is passed through an intermediate duct 67, and is blown to the recording side of the cut recording paper 1 from nozzles 68, and moisture on the recording side is blown off, and the paper is dried, and the print is finished.

At this time, if water droplets of the treating solution are left over on the surface of the cut recording paper 1 to be finished as the print, these water droplets are small in surface area and are difficult to dry, and the water droplets may remain and give drying blemishes to the print surface.

It may appear as periodic blemishes synchronized with the roller peripheral length, and in a worst case, if discharged to the sorter 50 before being dried completely, discharged prints stick to each other, and jamming may occur.

Accordingly, the squeezing unit 61 is provided for removing water droplets on the surface immediately before the cut recording paper 1 is delivered into the drying section 62, and surface water droplets are squeezed by the squeezing roller pair 7, and drying is promoted.

However, at the trailing edge of cut recording paper 1, in particular, the moisture of the surface squeezed by the squeezing roller pair 7 is pushed out, and there is the problem of these being conveyed as water droplets to the drying section 62.

Thus in the invention, as shown in FIG. 3B, drying air is blown from nozzles 2A, 2B to both sides of the cut recording paper 1 at the timing immediately before being conveyed from the squeezing unit 61 to the drying section 62, and water droplets not removed by physical pressure of squeezing roll pair 7 remaining on the surface are blown away by the pressure of the drying air, or pressed flat so as to be easily dried, and problems due to water droplets remaining on the surface of the recording paper 1, especially at the base side, can be prevented.

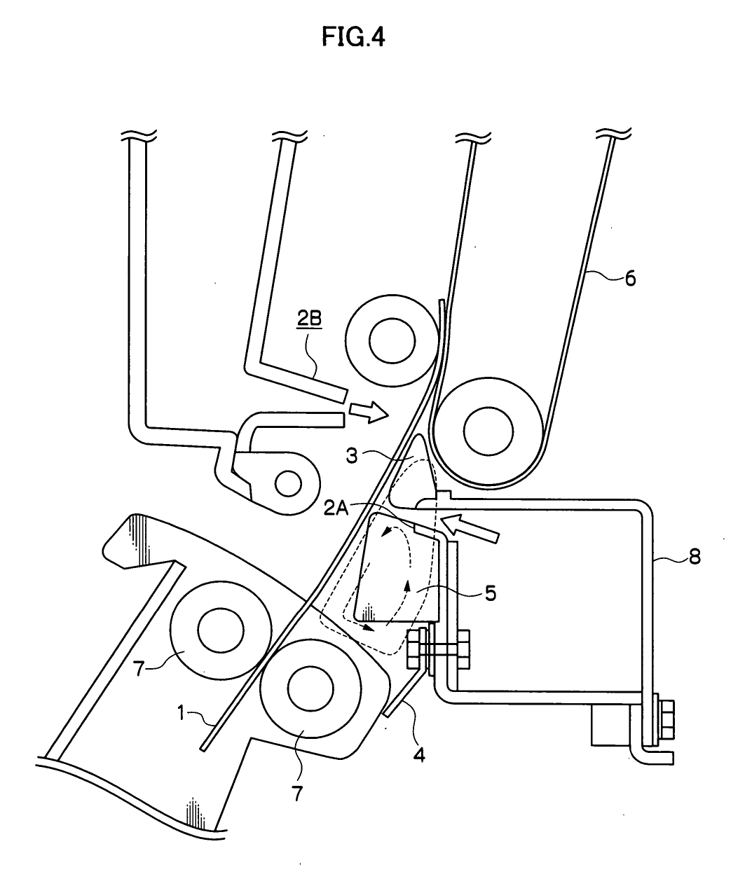

FIG. 4 shows the inlet area of drying section of the image recording apparatus according to the first embodiment of the invention. In a substantially triangular space formed by the cut recording paper 1, squeezing roller pair 7, rubber blade 4, guide 5, air duct 8, and guide 3 as shown in FIG. 4, the drying air blown from the air duct 8 to the base side of cut recording paper 1 (reverse side of recording side) through nozzle 2A is circulating, and a swirl is formed. As a result, the atmospheric pressure in the triangular space is raised, and water droplets are pressed flat, and drying efficiency is improved.

To obtain this effect, it is necessary to keep the triangular space airtight while the cut recording paper 1 is being conveyed, and the rubber blade 4 is provided for closing the gap between the squeezing roller pair 7 and air duct 8. If the guide 3 and guide 5 occupy the interior of the triangular space, the drying air does not circulate smoothly, and an air passage must be secured for drying air.

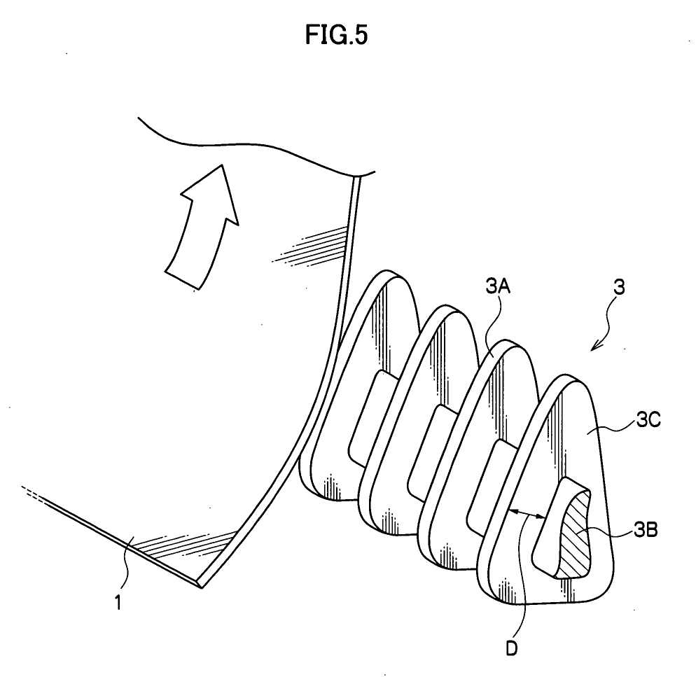

FIG. 5 shows the inlet area of drying section of the image recording apparatus according to the first embodiment of the invention.

For example, the guide 3 is formed as shown in FIG. 5, in which a rib 3C is provided on a shaft 3B, and the cut recording paper 1 is conveyed on the conveying surface 3A while a gap D is kept between the shaft 3B and cut recording paper 1, and hence the triangular space is ensured and the air passage for circulation of drying air is maintained.

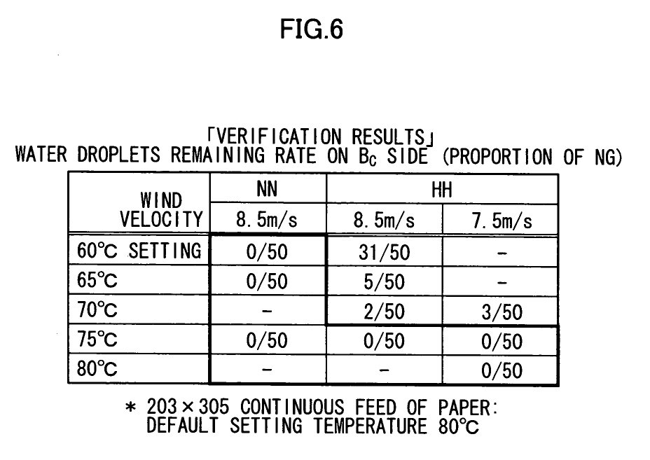

The effect of the squeezing unit 61 and drying section 62 structured as above can be confirmed in the form of the water droplet remaining rate (NG rate) on the Bc side (base side) as shown in FIG. 6. That is, in the condition of normal temperature and normal humidity (NN) and high temperature and high humidity (HH), results of processing 50 sheets of maximum paper size conveyed in mini laboratory, 8×12 (203×305 mm), are shown in FIG. 6.

If the default conditions were a drying temperature of 80° C. and air velocity is 8.5 m/s, at normal temperature and normal humidity, if the drying temperature is lowered to 60° C., water droplets do not remain on the Bc side.

In the more severe conditions of high temperature and high humidity, at the same air velocity of 8.5 m/s, water droplets are not left over if the drying temperature is lowered to 75° C., and even when the wind velocity is lowered to 7.5 m/s, water droplets are not left over.

Thus, with the above-described structure in which the drying efficiency is enhanced by keeping the triangular space airtight, and pushing the water droplets flatly by increasing the pressure of air convecting in a swirl in the space, a safety margin of 5° C. in drying temperature and 1 m/s in wind velocity is guaranteed.

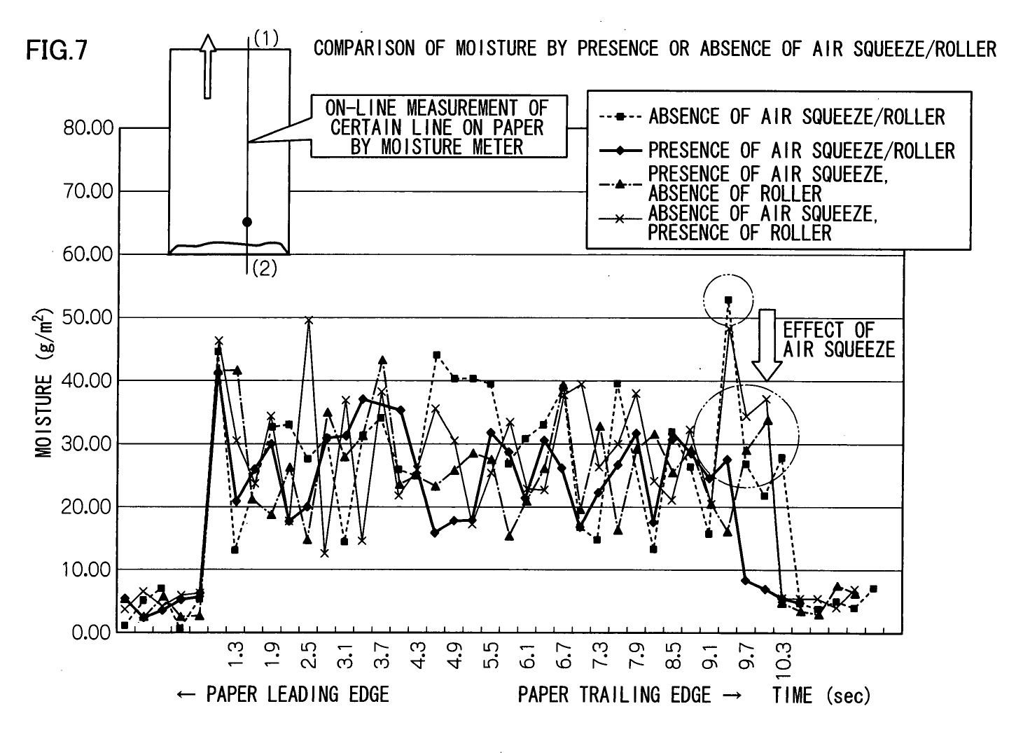

FIG. 7 shows fluctuations of moisture on the cut recording paper 1.

As shown in FIG. 7, on the Bc side of cut recording paper 1, the moisture is measured from the leading edge to trailing edge of the paper, effects are checked in the presence and absence of air squeeze/squeezing roller.

The moisture (g/m²) is plotted on the axis of ordinates, and the position on the cut recording paper 1 on the axis of abscissas, and shows the moisture at the trailing edge of paper was about 53 g/m² in the absence of the air squeeze and squeezing roller, and the moisture was about half that, or about 27 g/m², in the presence of the air squeeze and the squeezing roller of the invention, and the efficacy of the invention is confirmed.

For example, in any system in which a sheet subjected to a liquid impregnation process is conveyed through a drying process, the structure of the squeezing unit and drying section according to the invention can be used.

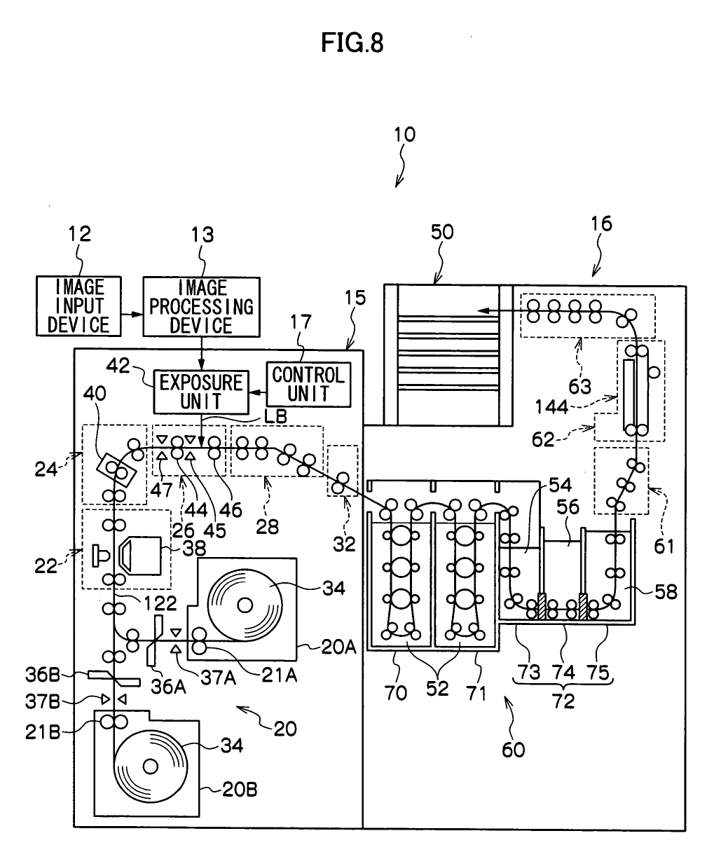

Referring now to FIG. 8 to FIG. 13, a second embodiment of the invention will be described below.

FIG. 8 is a schematic view showing the structure of the printer processor 10 which serves as image forming apparatus in which the photosensitive material drying apparatus is applied. The same parts as in FIG. 1 are identified with same reference numerals, and explanation is omitted.

The cut recording paper as photosensitive material of the embodiment is, for example, general purpose Glossy (trade name), highest stiffness Supreme Paper (trade name), mat or luster surface types, medium thick types for postcard, or other recording papers.

The print size is, for example, L (89×127), panorama (89×254), 2L (127×178), octo (165×216), sexto (203×254), and quarto (254×305), and the embodiment is applicable to all of these print sizes, and is also applicable to cut recording paper of length in conveying direction of 82.5 mm, and width in direction orthogonal to conveying direction of 89 mm. The embodiment is also applicable to thickness of cut recording paper ranging from 0.2 to 0.3 mm.

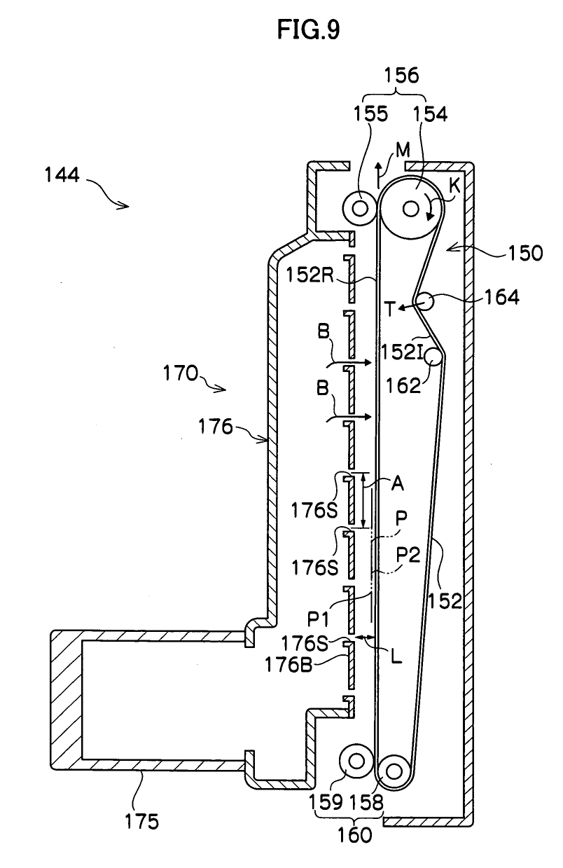

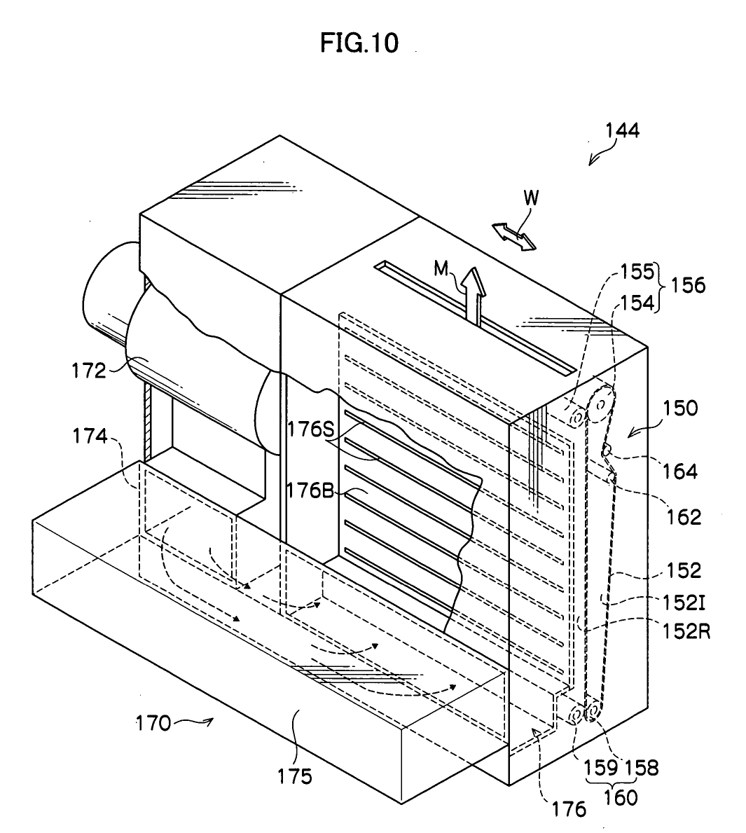

FIG. 9 and FIG. 10 show the general outline of drying apparatus 144 as a drying section. The drying apparatus 144 includes a rotary belt mechanism 150 for conveying cut recording paper P (see FIG. 2), and a drying mechanism 170 for drying the cut recording paper P.

The rotary belt mechanism 150 includes a mesh belt 152 as endless conveying belt. As shown in FIG. 9, the outer side 152R of the mesh belt 152 faces the reverse side P2 of the photosensitive side P1 of cut recording paper P. and the cut recording paper P is conveyed vertically upward (in direction of arrow M) by circulating motion.

The mesh belt 152 is supported from inside by three rollers, belt driving roller 154 and driven rollers 158, 162, and is entrained on these rollers at a specified tension, so that the cut recording paper P can be conveyed upward (in direction of arrow M) to the delivery unit 63 (see FIG. 8).

At an upper part of the drying apparatus 144 the belt driving roller 154 having the mesh belt 152 wrapped thereon is designed to receive a driving force from driving means such as motor (not shown) via transmission means such as drive transmission gear. Consequently, the belt driving roller 154 rotates in the clockwise direction in FIG. 9 (direction of arrow K), and the mesh belt 152 is circulatingly moved.

At the opposite position of belt driving roller.154, an opposite nip roller 155 is disposed, and the belt driving roller 154 and opposite nip roller 155 constitute a drive roller pair 156 for nipping and conveying the mesh belt 152.

A tension roller 164 disposed beneath the belt driving roller 154 abuts against the outer side 152R of the slack side of mesh belt 152, and is urged from the outer side 152R to the inner side 152I of mesh belt 152 (direction of arrow T) by biasing means (not shown), so that a tension is applied to the mesh belt 152.

The driven roller 162 beneath the tension roller 164 abuts against the inner side 152I of the mesh belt 152, and is driven to follow the circulating motion of the mesh belt 152.

The driven roller 158 disposed at a lower part of the drying apparatus 144 abuts against the inner side 1521 of the mesh belt 152, and is driven to follow the circulating motion of the mesh belt 152. At the opposite position of driven roller 158, an opposite roller 159 is disposed, and the driven roller 158 and opposite roller 159 constitute a driven roller pair 160 to be driven by pinching the mesh belt 152. The opposite roller 159 sends out the cut recording paper P. pushing out the curl (tendency to wind up), so as to be flat.

As shown in FIG. 10, the drying mechanism 170 includes a blower 172, a duct 174, an intermediate chamber 175, and a blasting case 176. The blower 172 is disposed at the side of the rotary belt mechanism 150, and sucks in the air. The duct 174 communicates with the lower part of the blower 172, and a heater (not shown) is incorporated in the duct 174. When the air from the blower 172 passes through the duct 174, the air is heated to be high-temperature drying air.

A hollow intermediate chamber 175 communicates with and is connected to the duct 174. The intermediate chamber 175 projects out from a lower part of the drying apparatus 144, and is extends in the direction in which the rotary belt mechanism 150 and duct 174 are arranged. The blasting case 176 is connected in communication with the intermediate chamber 175, and provided at a position opposite to the mesh belt 152. The air sucked in from the blower 172 is heated in the duct 174, and is sent out into the blasting case 176 via the intermediate chamber 175.

The blasting case 176 is a flat box, and has a blasting plate 176B disposed oppositely to the conveying portion of the mesh belt 152 (the area for conveying the cut recording paper P (see FIG. 9)).

The spacing between the blasting plate 176B shown in FIG. 9 and the outer side 152R in the conveying portion of the mesh belt 152 is preferably 6 mm to 10 mm, and it is set at 10 mm in the embodiment. A blowing slit 176S is formed in the blasting plate 176B, and the blowing slit 176S is provided at opposite position at a distance L (mm) of 6 mm≦L≦10 mm, from the outer side 152R in the conveying portion of the mesh belt 152, and L is 10 mm in the embodiment. A plurality of blowing slits 176S are provided along the conveying direction (direction of arrow M), being extended in the conveying width direction (direction of arrow W) as shown in FIG. 10.

Accordingly, as shown in FIG. 9, the drying mechanism 170 is designed to dry the cut recording paper P by blowing drying air from the blowing slit 176S toward the outer side 152R (direction of arrow B) of the mesh belt 152. By defining in a range of 6 mm≦L≦10 mm, the wind pressure of drying air necessary for the cut recording paper P can be assured easily.

As the drying air is blown to the mesh belt 152, the cut recording paper P is pressed against the outer side 152R of the mesh belt 152, and is conveyed and dried. The drying air blowing through the mesh belt 152 is sucked again by the blower 172 (see FIG. 3), and is circulated.

In the present embodiment, the-blowing slit 176S is formed at pitch A of 40 mm or less in the conveying direction (direction of arrow M). By defining pitch A of blowing slit 176S at 40 mm or less, drying air from two lines is always blowing onto cut recording paper P, even of the minimum size (length in conveying direction: 82.5 mm).

The wind velocity V (m/s) of drying air of drying mechanism 170 blowing to the cut recording paper P is preferably V≧6 m/s, and it is set at the minimum of 6 m/s in the present embodiment. The wind velocity V (m/s) of drying air from the blowing slit 176S formed at opposite position of distance L mm from the outer side of mesh belt 152 of 6 mm≦L≦10 mm is set at V≧6 m/s, and by the large wind pressure of the drying air, a gap is formed between the blasting plate 176B of the blowing slit 176S and the photosensitive side P1 of the cut recording paper P, and friction of photosensitive side P1 to the blasting plate 176B is prevented.

The wind velocity V (m/s) of drying air of drying mechanism 170 blowing to the cut recording paper P is V≧6 m/s as mentioned above, and the relation of wind velocity V (m/s) of drying air and coefficient of static friction μ of mesh belt 152 is set so that μ≧0.0082 V²−0.1968 V+1.3 (in the case of 6≦V≦12), or μ≧0.10 (in the case of V>12), and μ is 1.0 in the embodiment. By setting the relation of wind velocity V (m/s) of drying air and coefficient μ of static friction of mesh belt 152 at μ≧0.0082 V²−0.1968 V+1.3 (in the case of 6≦V≦12), or μ≧0.10 (in the case of V>12), the cut recording paper P can be conveyed vertically upward by the mesh belt 152.

The operation of the second embodiment will be explained next.

In the drying apparatus 144 shown in FIG. 9, the mesh belt 152 is circulatingly moved by the belt driving roller 154. At this time, the drying mechanism 170 is blowing drying air toward the mesh belt 152 from the blowing slit 176S, and the blown drying air passes through the mesh belt 152. As a result, the back side P2 of photosensitive side P1 of cut recording paper P is pressed against the outer side 152R of mesh belt 152, and is vertically conveyed upward, and dried, and sent out into the delivery unit 63 (see FIG. 8).

Herein, while the interval is set at 10 mm between the blowing slit 176S of blasting plate 176B and the outer side 152R of conveying portion of mesh belt 152, since the coefficient of static friction μ=1.0 of the mesh belt 152 of the embodiment is sufficiently large as compared with wind velocity 6 m/s of drying air from the blowing slit 176S, the cut recording paper P does not fall under gravity, but is conveyed vertically upward.

Also when the interval is set at 10 mm between the blowing slit 176S of blasting plate 176B and the outer side 152R of conveying portion of mesh belt 152, the wind pressure of drying air (wind pressure at wind velocity 6 m/s) from the blowing slit 176S is sufficiently higher than the curl restoring force of the cut recording paper P, and so a gap is formed between the photosensitive side P1 of the cut recording paper P and the blasting plate 176B. As a result, friction of photosensitive side P1 of cut recording paper P against the blasting plate 176B is prevented during the conveying process.

### TEST EXAMPLES 1, 2

To confirm the action of the embodiment, tests were conducted using two types of drying apparatus (called test example 1 and test example 2).

The cut recording paper to be conveyed (photosensitive material) was Supreme Paper (trade name) of 0.3 mm in thickness, and the paper size was 89 mm×82.5 mm.

Test example 1 was similar in structure to the drying apparatus of the embodiment, except that the wind velocity of drying air blown toward the mesh belt (conveying belt) and the coefficient of static friction Z of mesh belt (conveying belt) were changed.

Test example 2 was similar in structure to test example 1, except that the conveying angle of cut recording paper (photosensitive material) by the mesh belt (conveying belt) was set at 75°.

In test examples 1 and 2, the wind speed and, at each wind velocity, the coefficient of static friction μ of mesh belt (conveying belt) were changed, and the minimum value of the coefficient of static friction μ of mesh belt (conveying belt) capable of conveying the cut recording paper (photosensitive material) was investigated.

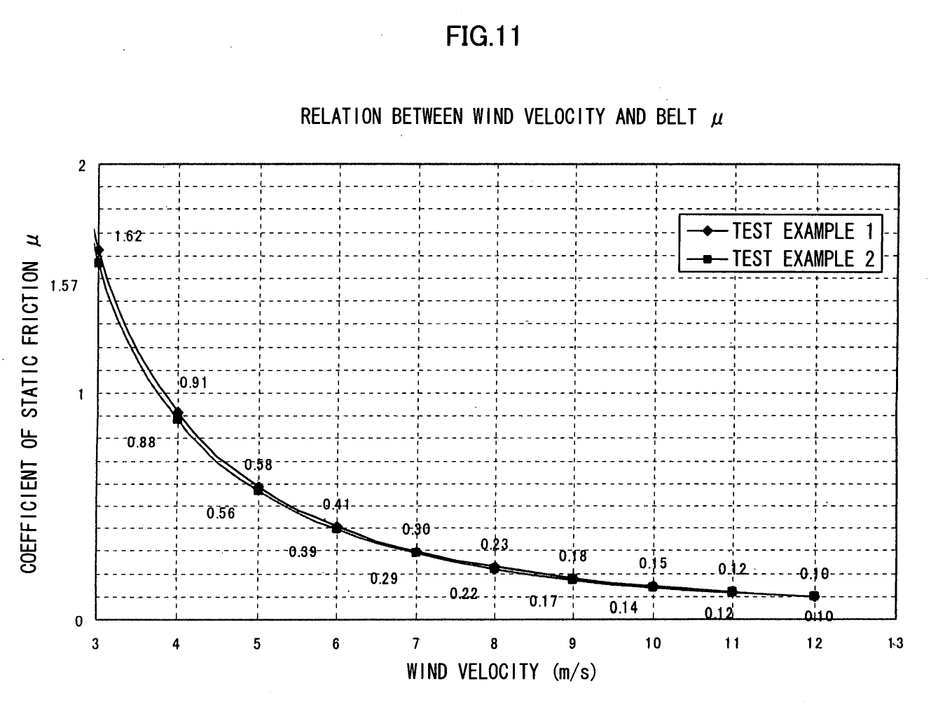

Results are shown in FIG. 11. As shown in FIG. 11, the results of test example 1 and test example 2 show substantially identical curves.

From the graph of FIG. 11, it is confirmed that the cut recording paper (photosensitive material) can be conveyed vertically upward and also conveyed upward by 75°, as far as the relation of wind velocity V (m/s) of drying air and coefficient μof static friction of mesh belt 152 is μ≧0.0082 V²−0.1968 V+1.3 (in the case of 6≦V 12), or μ≦0.10 (in the case of V>12).

In a structure similar to the above-described ones, when the distance L (mm) from the outer side at the conveying portion of the mesh belt (conveying belt) to the blowing slit is in a range of 6 mm≦L≦10 mm, the wind pressure to the cut recording paper P is higher than when L=10 mm. As a result, in this case, too, the cut recording paper (photosensitive material) can be conveyed vertically upward and also conveyed upward by 75°.

### TEST EXAMPLE 3 to 5

To confirm the action of the second embodiment, tests were conducted using three types of drying apparatus (called test examples 3 to 5). The cut recording paper to be conveyed (photosensitive material) was Supreme Paper (trade name) of 0.3 mm in thickness, and the paper size was 89 mm×82.5 mm.

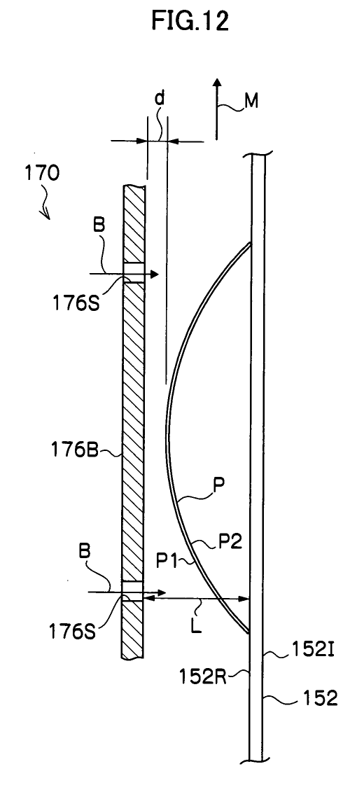

Test example 3 was similar in structure to the drying apparatus of the present embodiment, except for the following points. In FIG. 12, which schematically shows test example 3, same parts as those of the foregoing embodiment are identified with same reference numerals, and explanation thereof is omitted.

As shown in FIG. 12, the cut recording paper P is previously curled so that the intermediate portion in the conveying direction (direction of arrow M) becomes convex to the blasting plate 176B side, and the drying mechanism 170 is designed to blow drying air to the upper and lower end sides of cut recording paper P (downstream side and upstream side in conveying direction). That is, assuming a worst-case state in the conveying operation, in which the drying air was blown at a portion in which it is difficult to correct the curl.

In test example 3, as in the above-described embodiment, the distance from the outer side 152R at the conveying portion of the mesh belt 152 (conveying belt) to the blasting plate 176B, that is, the distance L (mm) from the outer side 152R to the blowing slit 176S is L=10 mm.

Test example 4 is similar in structure to test example 3, except that the distance from the outer side 152R at the conveying portion of the mesh belt 152 (conveying belt) to the blasting plate 176B, that is, the distance L (mm) from the outer side 152R to the blowing slit 176S is L=8 mm.

Test example 5 is similar in structure to test example 3, except that the distance from the outer side 152R in the conveying portion of the mesh belt 152 (conveying belt) to the blasting plate 176B, that is, the distance L (mm) from the outer side 152R to the blowing slit 176S is L=6 mm.

In each of the above-described structures, the velocity of drying air blown to the mesh belt 152 was changed to 6 m/s, 8 m/s, and 10 m/s, the shortest distance d (gap) of the blasting plate 176B and cut recording paper P was measured at each velocity.

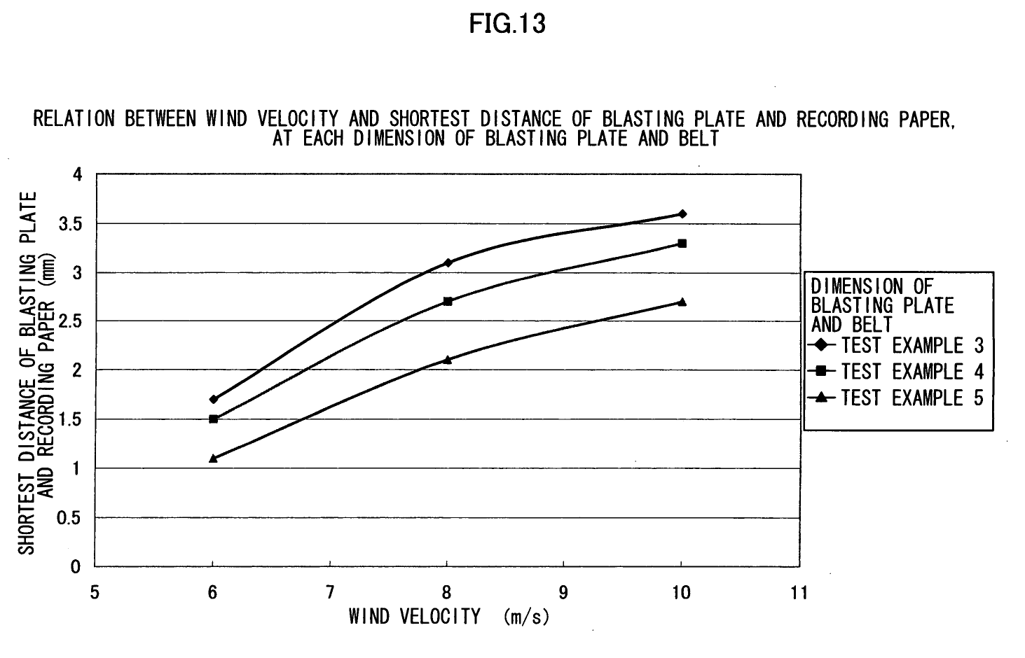

The results of the tests are shown in FIG. 13. As shown in the graph of FIG. 13, when the wind velocity V (m/s) of drying air blown toward the mesh belt 152 is V≧6 m/s, the shortest distance d (gap) of the blasting plate 176B and cut recording paper P is 1.7 mm or more in test example 3 (L=10 mm), 1.5 mm or more in test example 4 (L=8 mm), and 1.1 mm or more in test example 5 (L =6 mm). Hence, under the foregoing conditions, the shortest distance d (gap) of the blasting plate 176B and cut recording paper P is maintained at 1.1 mm or more, and it is confirmed that the photosensitive side P1 of cut recording paper P does not contact with the blasting plate 176B.

While some specific embodiments of the invention have been illustrated and described, it is to be understood that the present invention is by no means limited thereto, and encompasses all changes and modifications which will become possible without departing from the scope of claims.

What is claimed is:

1. A recording medium drying apparatus wherein a recording medium, which has been subjected to a liquid impregnation process, is pressed against a circulating mesh belt by blowing air from an image recording surface side to the recording medium, and dried while being held on the circulating mesh belt and conveyed, the apparatus comprising:
a blowing unit provided upstream in the conveying direction of the mesh belt and structured such that liquid droplets on the surface of the recording medium are removed with air blown from the blowing unit.

2. The recording medium drying apparatus of claim 1, wherein the blowing unit is structured so as to blow air from both sides of the recording medium.

3. The recording medium drying apparatus of claim 1, further comprising:
a conveying guide, for guiding the surface of the recording medium, disposed near the blowing unit, and having protrusions on a surface thereof, and an air passage, formed between the recording medium and the protrusions, for permitting drying air blown back from the recording medium to be recirculated.

4. The recording medium drying apparatus of claim 2, further comprising:
a conveying guide, for guiding the surface of the recording medium, disposed near the blowing unit, and having protrusions on a surface thereof, and an air passage, formed between the recording medium and the protrusions, for permitting drying air blown back from the recording medium to be recirculated.

5. A photosensitive material drying apparatus comprising:
an endless conveying belt, whose outer periphery faces the reverse face of the photosensitive material, for conveying the photosensitive material vertically upward by circulating motion; and
a drying mechanism, for drying the photosensitive material by blowing drying air from the blowing slit toward the conveying belt, having a blowing slit formed at a position opposite to, and at a distance L (mm) that is 6 mm≦L≦10 mm from, the outer periphery at the conveying portion of the conveying belt, wherein the velocity V (m/s) of the drying air is V≧6 m/s, and the relationship between the velocity V (m/s) of the drying air and a coefficient of static friction μ of the conveying belt is μ≧0.0082 V²−0.1968 V+1.3 (when 6≦V≦12), or μ≧0.10 (when V>12).

6. The recording medium drying apparatus of claim 1, further comprising an endless conveying belt, whose outer periphery faces the reverse face of [ ] a photosensitive material, for conveying the photosensitive material vertically upward by circulating motion; and
a drying mechanism, for drying the photosensitive material by blowing drying air from the blowing slit toward the conveying belt, having a blowing slit formed at a position opposite to, and at a distance L (mm) that is 6 mm≦L≦10 mm from, the outer periphery at the conveying portion of the conveying belt,
wherein the velocity V (m/s) of the drying air is V≧6 m/s, and
the relationship between the velocity V (m/s) of the drying air and a coefficient of static friction R of the conveying belt is μ≧0.0082 V²−0.1968 V+1.3 when 6≦V≦12, and μ≧0.10 when V>12.
